(19) United States
(12) Patent Application Publication
(10) Pub. No.: US 2002/0117379 A1
(43) Pub. Date: Aug. 29, 2002

(54) Cross-stacker

(75) Inventors: Gunter Gammerler, Gelting (DE); Peter Kunz, Geretsried (DE)

Correspondence Address: FITCH EVEN TABIN AND FLANNERY, 120 SOUTH LA SALLE STREET, SUITE 1600, CHICAGO, IL, 60603-3406, US

(73) Assignee: Gammerler AG

(21) Appl. No.: 10/058,981

(22) Filed: Jan. 28, 2002

(30) Foreign Application Priority Data
Jan. 30, 2001 (DE) 201 01 566.8

(51) Int. Cl. B65G 25/04

(52) U.S. Cl. 198/747

(57) ABSTRACT

The invention relates to a cross-stacker for paper products comprising a lift table which can be rotated around a vertical axis and which can be moved in a vertical direction. Furthermore an ejector arm movable parallel to the ejection direction and an ejector for ejecting a product stack from the cross-stacker are provided, with the ejector being held movably perpendicular to the ejection direction at the ejector arm.

### FIELD OF THE INVENTION

The present invention relates to a cross-stacker for paper products, in particular comprising an ejector for the ejection of a product stack from the cross-stacker.

### BACKGROUND OF THE INVENTION

Cross-stackers are generally known and serve for the stacking of a supplied stream of paper products into bundles, with these bundles having part-bundles rotated through 180°. A lift table, which is movable in the vertical direction and which is lowered as the stack formed grows, is provided for this purpose. This lift table is additionally rotatable around a vertical axis so that an arrangement of the part stacks can take place offset by 180° by a corresponding rotation of the lift table. When the stack formed on the lift table has reached a pre-determined height, it is removed from the cross-stacker. This can take place, on the one hand, by an ejector which is moved horizontally over the lift table, whereby the stack is pushed off the lift table down onto a transferring medium. The ejector is located in a position to the side of the lift table for this purpose during the stacking so that it is only moved in the ejection direction. It is furthermore possible for the stack to be removed from the cross-stacker, for example, by a grip.

Since cross-stackers are used in continuously working plants, both constructions have the disadvantage that in the event of malfunctions in the plant parts downstream of the cross-stacker, both the cross-stacker and the plant parts upstream of it have to be switched off Substantial costs are caused by such a switching off.

### SUMMARY OF THE INVENTION

It is the object of the invention to provide a cross-stacker in which product stacks can be ejected from the cross-stacker to other devices in the event of malfunctions in the downstream processing stages.

This object is satisfied by a cross-stacker having the features in accordance with claim 1.

The cross-stacker of the invention includes a lift table for the forming of the product stacks which can be rotated around a vertical axis and which can be moved in a vertical direction.

Furthermore, an ejector arm, which is movable parallel to the ejection direction, and an ejector for the ejection of a product stack out of the cross-stacker are provided, with the ejector being movable held perpendicular to the ejection direction at the ejector arm. The ejector is an element which is suitable to push product stacks from the lift table.

Since the ejector is movably held perpendicular to the ejection direction at the ejector arm, it is possible only to travel the ejector into the region of the lift table as required in order to then move it in the ejection direction for the removal of product stacks. It is in particular possible to hold the ejector at the removal side of the lift table in a waiting position outside the product-guiding region and only to extend it into a working or ejecting position in the region of the lift table as required in order to push product stacks from the lift table against the normal removal direction. It is ensured in this way that in the event of malfunctions in plant parts downstream of the cross-stacker, the plant parts upstream of the cross-stacker can keep on working continuously.

To move the ejector from a waiting position into a working position for the ejection, it is only necessary with a cross-stacker of the invention to move the ejector to the ejector arm. Since only relatively low masses thus have to be accelerated, a fast extension into the ejection position is made possible.

Preferred embodiments and further developments of the invention are described in the description, the claims and the drawings.

The lift table can also have recesses and/or slots in order to reduce the friction of the product stack on its surface and/or in order to reduce the inertia moment.

The ejector preferably extends at least over the overall height of a product stack to be ejected when it is located in the region of the lift table. The ejector can in particular be a rod or a correspondingly dimensioned hollow section.

The ejector is preferably movable in a plane parallel to the lift table by a movement of the ejector arm and by a movement of the ejector at the ejector arm, whereby a low build height results. The ejector is furthermore preferably movable into or out of the region carrying the product so that it does not represent an obstacle during operation without ejection.

It is generally sufficient for the above-described function of the ejector that the ejector can be moved by a movement at the ejector arm from a waiting position into a working position directly behind the product stack and above the lift table. In a preferred embodiment, however, the ejector can be extended perpendicular to the ejection direction at a side edge of the lift table so that it is not located above the lift table before the actual ejection movement. The waiting position of the ejector can in this way be selected independently of the size of the products stacked on the lift table so that generally no new adjustment is required in dependence on the product size.

Although the ejector arm can generally be movably arranged beneath the lift table, in particular when the lift table has slots through which the ejector can be moved, in a preferred embodiment the ejector arm is movable in a plane above the lift table. A particularly simple design becomes possible in this way since then the lifting mechanism for the lift table can be arranged beneath the lift table without having to take the movement of the ejector arm into account.

The ejector arm can generally be moved parallel to the ejection direction by any desired drive means such as electric motors. In a particularly preferred embodiment, the movement of the ejector arm takes place, however, by a positioning cylinder, whereby a simple, but fast-response drive is provided. This can generally be hydraulic or pneumatic positioning cylinders.

In a further preferred embodiment, the ejector arm is designed as a telescope arm at whose extendable end the ejector is secured. This embodiment has the advantage that the ejector arm does not reach into the region of the lift table or into the removal region in the waiting position. It in particular becomes possible to arranged the ejector arm at any desired height above the lift table, with the ejector being able to be secured to the arm in the vertical direction at one of its ends or also at any desired position between its ends in the vertical direction. The torsion forces on the ejector arm, which occur due to the pushing of the product stack with the ejector, can be reduced by a suitable selection of the height at which the ejector arm is arranged above the lift table. From this aspect, it is particularly preferred for the ejector arm to be arranged above the lift table lowered for ejection at around half the height of a typical product stack.

Although different drive devices, in particular also electric motors, are suitable for the movement of the ejector at the ejector arm, in a further preferred embodiment, a positioning cylinder connected to the ejector arm is provided for the movement of the ejector in the direction perpendicular to the ejection direction. This can generally be pneumatic or also hydraulic positioning cylinders. In any case, a simple and fast-response drive is provided in this way so that a fast traveling out of the ejector from the waiting position into the ejection position is nevertheless made possible with a simple design.

In a further preferred embodiment, in which the ejector arm is formed as a telescopic arm, the rod of the positioning cylinder engages at the extendable part of the telescopic arm to move the ejector. The positioning cylinder is subject to particularly low stress in this way since the rod only needs to be very short when compared with engagement at the ejector itself.

In a further preferred embodiment, at least one recess is provided in the lift table which extends parallel to the ejection direction and in which the free end of the ejector confronting the lift table can be guided. It is hereby avoided, on the one hand, that product could be jammed in the bottommost layer between the ejector and the lift table and a side escape of the ejector is prevented, on the other hand.

In a further preferred embodiment, a further ejector is provided which can be moved parallel to and perpendicular to the ejection direction and which is movable in a direction opposite to the ejection direction of the first ejector. This further ejector can in particular likewise be held movably perpendicular to the ejection direction at an ejector arm movable parallel to the ejection direction. The ejectors are particularly preferably arranged with respect to the lift table such that product stacks can be moved from the lift table in two opposite direction.

A cross-stacker in accordance with this preferred embodiment can be operated in normal operation, in which no malfunctions occur in the downstream units, like a cross-stacker of the prior art in which a product stack is transferred to the downstream units by means of an ejector. Due to the possibility of moving both ejectors perpendicular to the ejection direction, in the event of malfunctions in the devices downstream of the cross-stacker, the ejector which ejects in normal operation can be moved by a movement perpendicular to its ejection direction from the working position in front of the part of the lift table carrying product into a waiting position and the further ejector can be moved from a waiting position into a working position in the region in front of or above the lift table so that the further ejector can eject product stacks in a direction opposite to the normal ejection direction. A continuous operation of the devices upstream of the cross-stacker is made possible in this way.

It is furthermore also possible with a cross-stacker from which product stacks can be removed in two opposite directions, in the event of malfunctions in one of the plant parts downstream of the cross-stacker, to be able to eject the product in the opposite direction with the respective ejector. This is particularly advantageous when only one cross-stacker is provided for two processing units for product stacks which are downstream of the cross-stacker and which are to be operated alternatively.

### BRIEF DESCRIPTION OF THE DRAWINGS

Preferred embodiments of the invention are now described by way of example with reference to the drawings. There are shown:

FIG. 1 a schematic plan view of a part of a cross-stacker in accordance with a first preferred embodiment of the invention;

FIG. 2 a schematic plan view of the cross-stacker in FIG. 1 in the region of the ejector arm;

FIG. 3 a schematic sectional view along the plane A-A in FIG. 2; and

FIG. 4 a schematic plan view of a part of a cross-stacker in accordance with a second preferred embodiment of the invention.

### DETAILED DESCRIPTION OF THE PREFERRED EMBODIMENTS

The Figures show only a part of the cross-stackers in accordance with two preferred embodiments of the invention, with only the elements being shown which are essential for the understanding of the invention. The remaining components of the cross-stacker are sufficiently known from the prior art and are not described in detail in the following.

A cross-stacker in accordance with a first preferred embodiment of the invention has a lift table 10 and a base frame 12 which is arranged next to it and at which two guide tubes 14 and 16 are secured on which an ejector arm 18 with an ejector 20, which is shown only by broken lines, is movably guided above the lift table 10. A first positioning cylinder 22 is moreover secured at the base frame 12 in order to move the ejector arm 18 along the guide tubes 14 and 16.

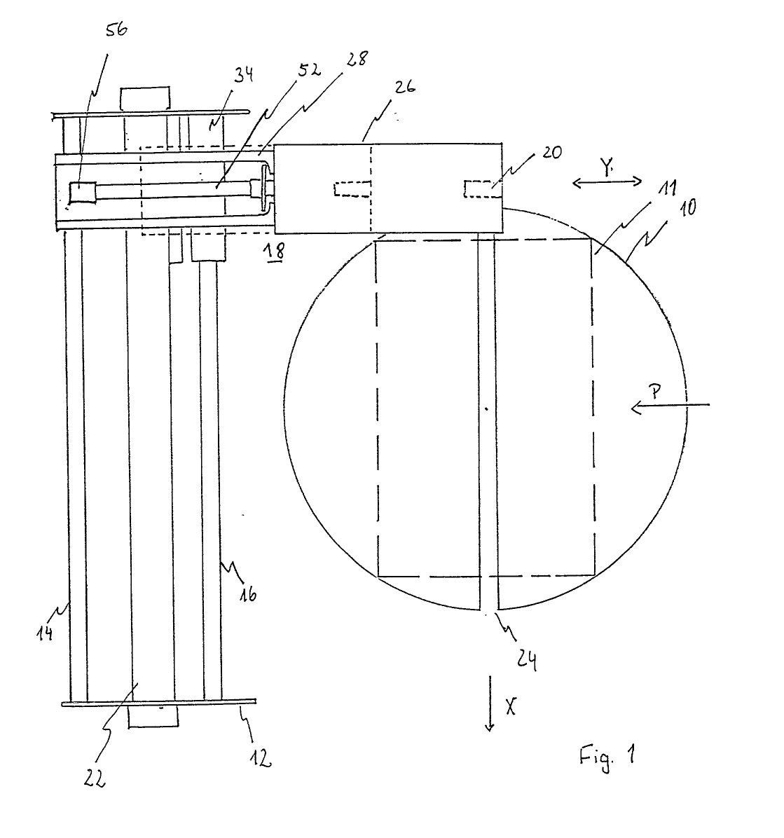

The lift table 10 can be moved in a vertical direction and is lowered successively on the supply of products from the direction P in order to form a product stack 11 shown by broken lines in FIG. 1. The lift table 10 can furthermore be rotated around a vertical axis between two stack positions mutually rotated through 180° in order to form part stacks offset by 180°. The lift plate 10 moreover has a recess 24 which extends along a diameter and which extends parallel to the guide tubes 14 and 16 in the stacking positions of the lift table 10.

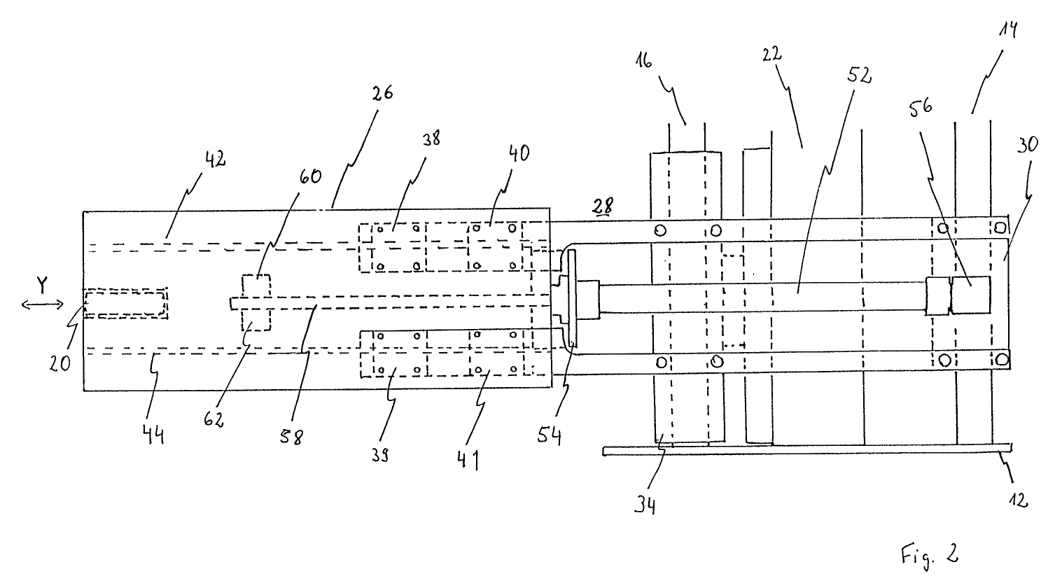

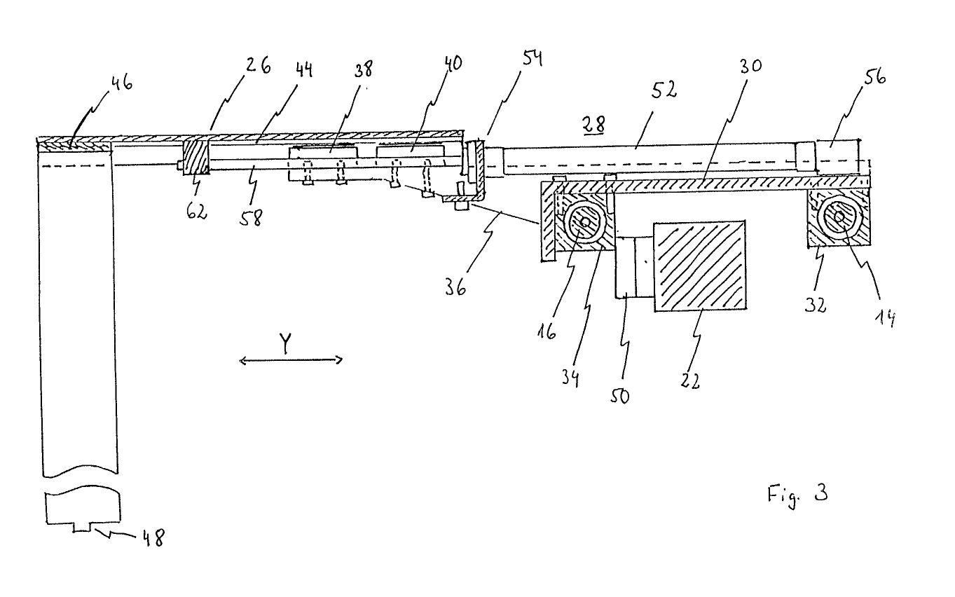

The ejector arm 18 is formed as a telescopic arm with a part 26 extendable in the direction Y and a base part 28 with which the ejector arm is moveably held at the guide tubes 14 and 16. The region of the ejector arm 18 is shown in more detail in FIGS. 2 and 3. The base part 28 has a base plate 30 which is carried by two guide blocks 32 and 34 secured to it and running on the guide tubes 14 or 16 (FIG. 3). The guide tubes 14 and 16 are in this respect mounted in the guide blocks 32 and 34 respectively by means of plain bearings which are not shown. An arm element 36 is furthermore secured to the base plate 30 and four rail bearings 38, 39, 40 and 41 are secured to its end directed away from the guide blocks 32 and 34.

The extendable part 26, which is formed by a U section, furthermore has rails 42 and 44 which extend parallel to the direction of the ejector arm and which run in the rail bearings 38 and 40 or 39 and 41 respectively. These rail bearings 38, 39, 40 and 41 are roller bearings which are designed and arranged such that a tilt movement in the vertical direction of the rails 42 and 44 and thus of the extendable part 26 is not possible. In this way, the extendable part 26 of the telescopic arm is movably held perpendicular to the guide tubes 16 such that it, as shown in FIG. 1, can be moved to an fro between a working position and an ejection position respectively which are shown by solid lines. The ejector 20, which is formed by a hollow section, is secured at the free end of the extendable part 26 via a connection plate 42, with said ejector hanging down from the ejector arm arranged above the lift table. The ejector 20 has a guiding pin 48 at its lower end and the ejector can be guided in the recess 24 of the lift table 10 by this.

The ejector arm 18 can be moved along the guide tubes 14 and 16 by means of a first positioning cylinder 22, for which purpose the guide block 34 is connected to the driving element of the positioning cylinder 22 via a connection element. This positioning cylinder 22 thus serves for the ejection of a product stack. (FIG. 3) The extendable part 26 of the ejector arm 18, and thus the ejector 20 secured thereto, can be moved in the Y direction, that is in the direction of the ejector arm and perpendicular to the guide tubes 14 and 16, via a second positioning cylinder 52, with the positioning cylinder 52 being fixedly connected to the ejector arm by a flange 54 secured to the arm element 36 and by a holder 56 secured to the base plate 30. The rod 58 of the positioning cylinder 52 is held between two blocks 60 and 62 connected to the extendable part 26 so that the extendable part 26 can be moved by means of the rod 58. As can be seen in FIG. 2, the rail bearings 38 to 41 are arranged such that the blocks 60 and 62 are movable between the rail bearings by the rod 58 and thus the extendable part 26 can be moved back as far as possible.

As shown in FIG. 1, during operation the ejector arm 18 is located at the end of the base frame which lies in the direction from which the product is removed from the lift table 10, with the extendable part 26, as shown by broken lines in FIG. 1, being in a retracted waiting position in which it is located outside the region of the lift table 10 carrying the stack 11 and so not hindering removal. In the event of a malfunction, the extendable part 26 is now fully extended via the positioning cylinder 52 such that the ejector with the guiding pin 48 (FIG. 3) comes to rest in front of the recess 24. For the ejection, the ejector arm is then moved by means of the positioning cylinder 22 in the ejection direction X, that is against the removal direction, against the product stack 11 which is thus ejected.

After the ejection, the ejector arm 18 with the ejector 20 can again be moved into the ejection position in order to again eject the next product stack after this has been formed. If an ejection by means of the ejector 20 is no longer necessary, the extendable part 26 with the ejector 20, which is in the working position, is again withdrawn into the waiting position shown in FIG. 1 by a broken line by means of the positioning cylinder 52.

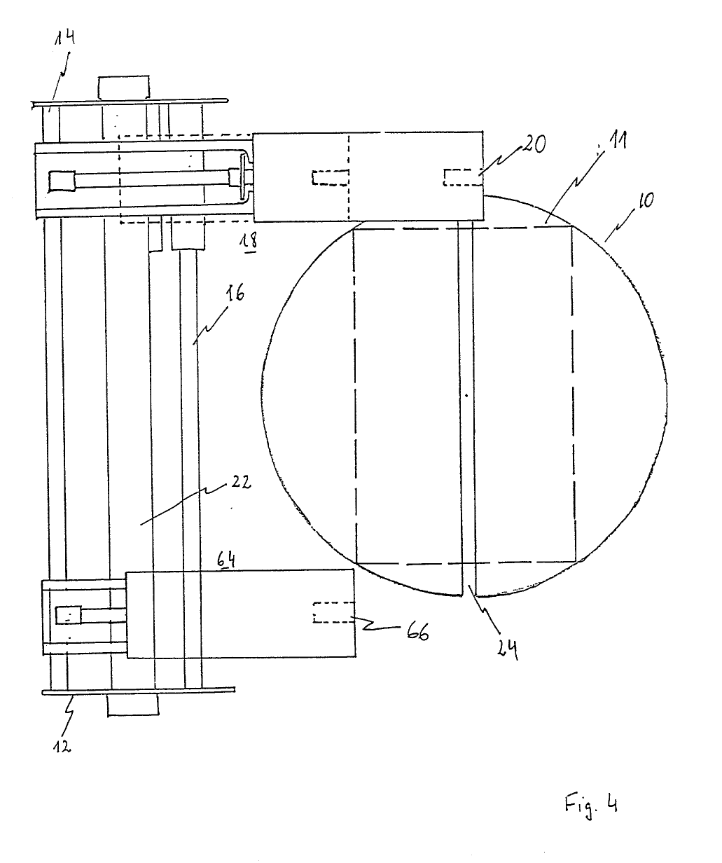

In FIG. 4, a second preferred embodiment of the invention is shown which substantially differs from the first embodiment in that the cross-stacker has a second ejector arm 64 which is movable above the lift table 10 and which has a second ejector 66 shown only by a broken line. The same reference numerals and designations are therefore used for the same elements in the description of this second preferred embodiment as in the first embodiment. The design and drive of the second ejector arm 64 with the ejector 66 correspond to those of the ejector arm 18 with the ejector 22 in the first preferred embodiment. The ejector arm 64 is likewise guided on the guide tubes 14 and 16, but is moved in the direction of the guide tubes by a second positioning cylinder not visible in FIG. 4.

In operation, the two ejector arms are located at opposite ends of the base frame 12. Depending on the requirement, one of the ejectors 66 is first moved from here in a direction parallel to the ejector arm from a waiting position next to the lift table into an ejection position in front of the lift table in order then to be moved along the guide tubes 14 and 16 together with the whole ejector arm for the purpose of ejecting a product stack.

We claim:

1. A cross-stacker for paper products comprising:
a lift table which can be rotated around a vertical axis and which can be moved in a vertical direction,
an ejector arm movable parallel to the ejection direction,
and an ejector for ejecting a product stack from the cross-stacker, with the ejector being held at the ejector arm and being movable perpendicular to the ejection direction.

2. A cross-stacker in accordance with claim 1 wherein the ejector can be extended perpendicular to the ejection direction at a side edge of the lift table.

3. A cross-stacker in accordance with claim 1 wherein the ejector arm can be moved in a plane above the lift table.

4. A cross-stacker in accordance with claim 1 including a positioning cylinder for the movement of the ejector arm parallel to the ejection direction.

5. A cross-stacker in accordance with claim 1 wherein the ejector arm is formed as a telescopic arm at whose extendable end the ejector is secured.

6. A cross-stacker in accordance with claim 5 including a positioning cylinder connected to the ejector arm for the movement of the ejector in the direction perpendicular to the ejection direction.

7. A cross-stacker in accordance with claim 6 wherein a rod of the positioning cylinder engages at the extendable part of the telescopic arm for the movement of the ejector.

8. A cross-stacker in accordance with claim 1 including at least one recess in which the free end of the ejector can be guided, extending in the lift table parallel to the ejection direction.

9. A cross-stacker in accordance with claim 1 including a further ejector which is movable parallel to and perpendicular to the ejection direction and which is movable in a direction opposite to the ejection direction of the first ejector.
